(19) United States
(12) Patent Application Publication
(10) Pub. No.: US 2025/0135843 A1
(43) Pub. Date: May 1, 2025

(54) VEHICLE HEAT PUMP SYSTEM

(71) Applicant: HANON SYSTEMS, Daejeon (KR)

(72) Inventor: Jae Min LEE, Daejeon (KR)

(21) Appl. No.: 18/851,453

(22) PCT Filed: Jun. 20, 2023
(86) PCT No.: PCT/KR2023/008526

§ 371 Date: Sep. 26, 2024

(30) Foreign Application Priority Data
Jul. 20, 2022 (KR) 10-2022-0089712

(51) Int. Cl. B60H 1/32; B60H 1/00

(52) U.S. Cl. CPC B60H 1/3227; B60H 1/00278; B60H 1/00485; B60H 1/00899; B60H 1/3228

(57) ABSTRACT

Vehicle heat pump system comprising a compressor for discharging a refrigerant; an indoor heat exchanger in an air-conditioning case, allowing heat exchange between air and the refrigerant; a water-cooled condenser downstream of the indoor heat exchanger in the flow direction of the refrigerant, exchanging heat with first cooling water; an outdoor heat exchanger downstream of the water-cooled condenser, allowing heat exchange between the refrigerant and outdoor air; an evaporator in the air-conditioning case, allowing heat exchange between the refrigerant and the air to cool the indoor space, and a chiller downstream of the outdoor heat exchanger exchanging heat with second cooling water. An outdoor unit bypass line allowing refrigerant to pass through the water-cooled condenser and bypass the outdoor heat exchanger, which branches off between the water-cooled condenser and the outdoor heat exchanger and is connected to the upstream side of the chiller in the flow direction of the refrigerant.

### TECHNICAL FIELD

The present invention relates to a vehicle heat pump system, and more particularly, to a vehicle heat pump system installed in an electric vehicle and using both a water-cooled condenser and an air-cooled condenser.

### BACKGROUND ART

In general, an air conditioner for a vehicle includes a cooling system for cooling the interior of the vehicle, and a heating system for heating the interior of the vehicle. The cooling system, at an indoor heat exchanger side of a refrigerant cycle, converts air passing the outside of an indoor heat exchanger into cold air by exchanging heat between the air and a refrigerant flowing inside an evaporator. Moreover, the heating system, at a heater core side of a cooling water cycle, converts the air passing the outside of the heater core into warm air by exchanging heat between the air and cooling water flowing inside the heater core to heat the interior of the vehicle.

Referring to FIGS. 1 and 2, a conventional vehicle heat pump system installed in an electric vehicle includes a compressor 8, an indoor heat exchanger 4, a first expansion valve 11, an outdoor heat exchanger 6, a second expansion valve 5, and an evaporator 3. Additionally, the conventional vehicle heat pump system further includes an accumulator 9 provided upstream of the compressor 8 in a refrigerant flow direction.

An evaporator bypass line 31 bypassing the evaporator 3 is formed between the outdoor heat exchanger 6 and the second expansion valve 5, and a first direction-changing valve 24 which controls a bypass refrigerant amount is further included. A chiller 14 is installed in the evaporator bypass line 31. The first expansion valve 11 has an orifice 21 installed in parallel with an expansion line 33 branched from a refrigerant line 30, and a two-way valve 22 is installed at the branching point.

Furthermore, an outdoor unit bypass line 32 bypassing the outdoor heat exchanger 6 is formed in the refrigerant line 30, and a second direction-changing valve 23 which controls the bypass refrigerant amount is further included. Additionally, a dehumidification line 34 is branched upstream of the second direction-changing valve 23 in the refrigerant flow direction, such that refrigerant is supplied to the evaporator 3. Moreover, the chiller 14 exchanges heat between the cooling water circulating vehicle electric components 35 and the refrigerant passing through the evaporator bypass line 31.

The evaporator 3 and the indoor heat exchanger 4 are sequentially provided in an air flow passage within the air-conditioning case 1 in an air flow direction. The evaporator 3 cools the air by exchanging heat with the air passing through the evaporator 3, and the indoor heat exchanger 4 heats the air by exchanging heat with the air passing through the indoor heat exchanger. A temperature door 2 for adjusting the temperature of air is provided between the evaporator 3 and the indoor heat exchanger 4. A PTC heater 7 can further be provided downstream of the indoor heat exchanger 4 in the air flow direction.

In a cooling mode, as illustrated in FIG. 1, the high-temperature and high-pressure refrigerant discharged from the compressor 8 passes through the indoor heat exchanger 4, directly passes through the first expansion valve 11, and then, goes through the outdoor heat exchanger 6. The refrigerant, which has passed through the outdoor heat exchanger 6, expands at the second expansion valve 5, and then, absorbs heat in the evaporator 3. After absorbing heat in the evaporator 3, the refrigerant passes through the accumulator 9, and then, circulates through the compressor 8. In this case, the air passing through the evaporator 3 is cooled by exchanging heat with the refrigerant, thereby performing cooling of the interior.

In a heating mode, as illustrated in FIG. 2, the high-temperature and high-pressure refrigerant discharged from the compressor 8 exchanges heat with the indoor air while passing through the indoor heat exchanger 4, to perform heating. The refrigerant passing through the indoor heat exchanger 4 expands while passing through the orifice 21 of the first expansion valve 11, absorbs heat while passing through the outdoor heat exchanger 6, circulates to the chiller 14 along the evaporator bypass line 31, and bypasses the evaporator 3. The refrigerant recovers waste heat of the electric components in the chiller 14, and then passes through the accumulator 9 and circulates through the compressor 8.

The conventional vehicle heat pump system has the limitation of recovering only waste heat of the electric components 35. To cool the battery waste heat using the conventional vehicle heat pump system, the conventional vehicle heat pump system can be configured such that a portion of the refrigerant passing through the outdoor heat exchanger branches towards a battery chiller. However, in this case, a refrigerant line for cooling the battery must be inevitably added, leading to an increase in the number of components.

### DISCLOSURE

### Technical Problem

Accordingly, the present invention has been made in view of the above-mentioned problems occurring in the related art, and it is an object of the present invention to provide a vehicle heat pump system which can minimize the number of expansion valves, realize various air-conditioning modes while, and significantly reduce manufacturing costs by using relatively low-priced components.

### Technical Solution

To accomplish the above-mentioned objects, according to the present invention, there is provided a vehicle heat pump system including: a compressor for discharging a refrigerant; an indoor heat exchanger which is provided in an air-conditioning case, and exchanges heat between air and the refrigerant discharged from the compressor to heat the interior; a water-cooled condenser which is provided downstream of the indoor heat exchanger in the refrigerant flow direction, and exchanges heat with first cooling water; an outdoor heat exchanger which is provided downstream of the water-cooled condenser in the refrigerant flow direction, and exchanges heat between the refrigerant and the outdoor air; an evaporator which is provided in the air-conditioning case, and exchanges heat between the refrigerant and the air so as to cool the interior; and a chiller which is provided downstream of the outdoor heat exchanger in the refrigerant flow direction, is provided in a refrigerant line bypassing the evaporator, and exchanges heat with second cooling water, wherein an outdoor unit bypass line, which allows the refrigerant passing through the water-cooled condenser to bypass the outdoor heat exchanger, is provided, and the outdoor unit bypass line branches off between the water-cooled condenser and the outdoor heat exchanger and connects upstream of the chiller in the refrigerant flow direction.

The vehicle heat pump system further includes a refrigerant flow direction-changing valve which is arranged at a connection portion between the outdoor unit bypass line and the refrigerant line upstream of the chiller, and functions as a three-way valve controlling the refrigerant passing through the water-cooled condenser to selectively pass through or bypass the outdoor heat exchanger, and expands the refrigerant.

The refrigerant flow direction-changing valve includes two inlets and one outlet, the first inlet is connected to a branch line between the water-cooled condenser and the outdoor heat exchanger, the second inlet is connected downstream of the outdoor heat exchanger in the refrigerant flow direction, and the outlet is connected to the chiller.

The first inlet performs only the on/off function of the refrigerant flow, and the second inlet is configured to perform the refrigerant flow on/off function and the refrigerant expansion function.

The vehicle heat pump system further includes: a first expansion valve which is positioned between the indoor heat exchanger and the water-cooled condenser, and selectively expands the refrigerant or allows the refrigerant to pass through without expansion; and a second expansion valve which is placed upstream of the evaporator in the refrigerant flow direction and expands the refrigerant.

The refrigerant flow direction-changing valve has an electronic expansion valve (EXV) structure capable of controlling the refrigerant amount, and the first expansion valve has an electronic expansion valve (EXV) structure capable of controlling the refrigerant amount, and the second expansion valve is a thermostatic expansion valve (TXV) performing only the expansion function.

The first cooling water circulates through electric components of a vehicle, and the second cooling water circulates through a battery of the vehicle.

The vehicle heat pump further includes a dehumidification line which branches off downstream of the indoor heat exchanger in the refrigerant flow direction and connects upstream of the evaporator, wherein the dehumidification line is connected between the second expansion valve and the evaporator.

The dehumidification line branches off between the indoor heat exchanger and the first expansion valve, and includes a third expansion valve capable of controlling the refrigerant amount and expanding the refrigerant.

The dehumidification line branches off between the first expansion valve and the water-cooled condenser, and includes a shut-off valve controlling only the refrigerant amount.

In a cooling mode, the refrigerant flow direction-changing valve closes all of the inlets to block the refrigerant flow, and controls the refrigerant to sequentially circulates through the compressor, the indoor heat exchanger, the first expansion valve, the water-cooled condenser, the outdoor heat exchanger, the second expansion valve, the evaporator, and the compressor. In a cooling and battery cooling mode, the refrigerant flow direction-changing valve opens only the inlet of the connection line downstream of the outdoor heat exchanger in the refrigerant flow direction and expands the refrigerant, so that a portion of the refrigerant passing through the outdoor heat exchanger is controlled to pass through the chiller.

In a maximum heating mode, the refrigerant flow direction-changing valve opens only the inlet of the connection line downstream of the outdoor heat exchanger in the refrigerant flow direction and allows the refrigerant to pass through directly so that the refrigerant is controlled to sequentially circulate through the compressor, the indoor heat exchanger, the first expansion valve, the water-cooled condenser, the outdoor heat exchanger, the refrigerant flow direction-changing valve, the chiller, and the compressor. In a partial heating mode, the refrigerant flow direction-changing valve opens only the inlet of the branch line between the water-cooled condenser and the outdoor heat exchanger so that the refrigerant is controlled to sequentially circulate through the compressor, the indoor heat exchanger, the first expansion valve, the water-cooled condenser, the refrigerant flow direction-changing valve, the chiller, and the compressor.

In a maximum heating and dehumidification mode, the refrigerant flow direction-changing valve opens only the inlet of the connection line downstream of the outdoor heat exchanger in the refrigerant flow direction and allows the refrigerant to pass through directly so that the refrigerant is controlled to sequentially circulate through the compressor, the indoor heat exchanger, the first expansion valve, the water-cooled condenser, the outdoor heat exchanger, the refrigerant flow direction-changing valve, the chiller, and the compressor, and a portion of the refrigerant passing through the indoor heat exchanger is supplied to the evaporator through the dehumidification line. In a partial heating and dehumidification mode, the refrigerant flow direction-changing valve opens only the inlet of the branch line between the water-cooled condenser and the outdoor heat exchanger so that the refrigerant is controlled to sequentially circulate through the compressor, the indoor heat exchanger, the first expansion valve, the water-cooled condenser, the refrigerant flow direction-changing valve, the chiller, and the compressor, and a portion of the refrigerant passing through the indoor heat exchanger is supplied to the evaporator through the dehumidification line.

In another aspect of the present invention, there is provided a vehicle heat pump system including: a compressor for discharging a refrigerant; an indoor heat exchanger which is provided in an air-conditioning case, and exchanges heat between air and the refrigerant discharged from the compressor to heat the interior; a water-cooled condenser which is provided downstream of the indoor heat exchanger in the refrigerant flow direction, and exchanges heat with first cooling water; an outdoor heat exchanger which is provided downstream of the water-cooled condenser in the refrigerant flow direction, and exchanges heat between the refrigerant and the outdoor air; an evaporator which is provided in the air-conditioning case, and exchanges heat between the refrigerant and the air so as to cool the interior; a chiller which is provided downstream of the outdoor heat exchanger in the refrigerant flow direction, is provided in a refrigerant line bypassing the evaporator, and exchanges heat with second cooling water; and a refrigerant flow direction-changing valve which functions as a three-way valve controlling the refrigerant passing through the water-cooled condenser to selectively pass through or bypass the outdoor heat exchanger, and expands the refrigerant, wherein the refrigerant flow direction-changing valve expands only the refrigerant passing through the outdoor heat exchanger.

### Advantageous Effect

The vehicle heat pump system according to the present invention can secure price competitiveness and realize all functions of the heat pump. That is, the vehicle heat pump system can realize all air-conditioning modes, such as the cooling mode, the cooling and battery cooling mode, the maximum heating mode, the maximum heating and dehumidification mode, the partial heating mode, and the partial heating and dehumidification mode, by controlling the refrigerant flow using total four valves. Namely, the vehicle heat pump system can operate the maximum heating mode and the maximum heating and dehumidification mode, which recover water heat source and air heat source, and also operate the partial heating mode and the partial heating and dehumidification mode, which recover only the water heat source. Moreover, the vehicle heat pump system can realize the cooling mode, the cooling and battery cooling mode, and the battery cooling only mode.

Additionally, the vehicle heat pump system can minimize the number of valves and realize an outdoor heat exchanger bypass mode, thereby effectively addressing the problems such as frosting of the outdoor heat exchanger or excessive waste heat from electric components. In addition, the double-tube (internal heat exchanger) is installed at the front end of the TXV (second expansion valve) after the battery chiller branch line based on the cooling mode, thereby minimizing the pressure loss of the refrigerant entering the chiller after passing the rear end of the outdoor heat exchanger during the heating mode.

### DESCRIPTION OF DRAWINGS

FIG. 1 illustrates a cooling mode of a conventional vehicle heat pump system.

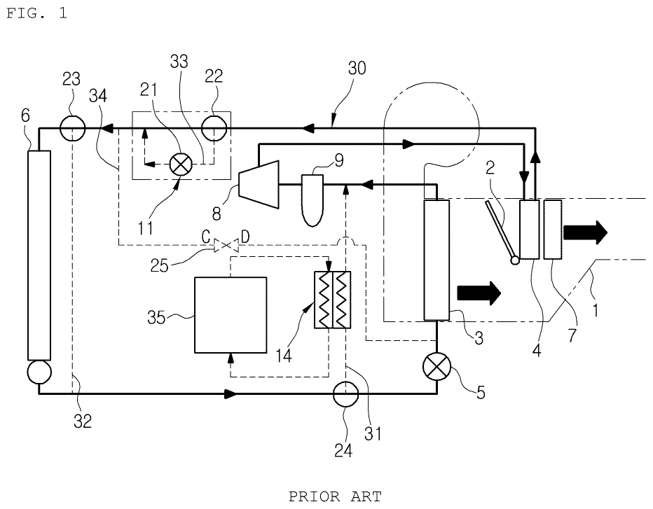

FIG. 2 illustrates a heating mode of a conventional vehicle heat pump system.

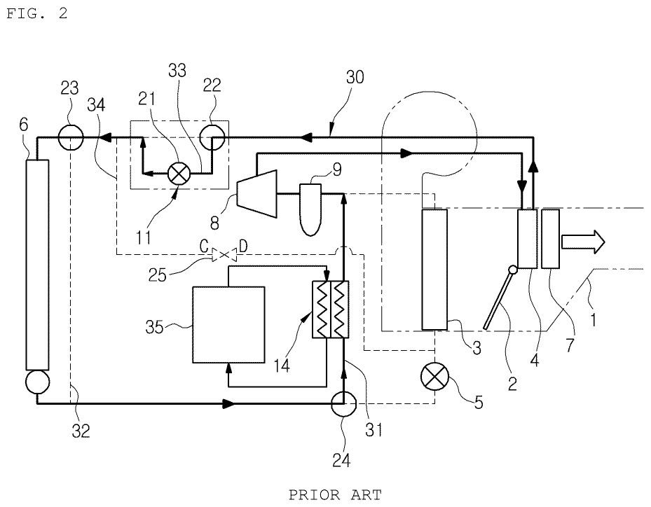

FIG. 3 illustrates a vehicle heat pump system according to a first embodiment of the invention,

FIG. 4 illustrates a refrigerant flow direction-changing valve of the vehicle heat pump system according to the first embodiment of the invention.

FIG. 5 illustrates a cooling mode of the vehicle heat pump system according to the first embodiment of the invention.

FIG. 6 illustrates a cooling and battery cooling mode of the vehicle heat pump system according to the first embodiment of the invention.

FIG. 7 illustrates a maximum heating mode of the vehicle heat pump system according to the first embodiment of the invention.

FIG. 8 illustrates a partial heating mode of the vehicle heat pump system according to the first embodiment of the invention.

FIG. 9 illustrates a maximum heating and dehumidification mode of the vehicle heat pump system according to the first embodiment of the invention.

FIG. 10 illustrates a partial heating and dehumidification mode of the vehicle heat pump system according to the first embodiment of the invention.

FIG. 11 illustrates a vehicle heat pump system according to a second embodiment of the invention.

FIG. 12 illustrates the maximum heating mode of the vehicle heat pump system according to the second embodiment of the invention.

FIG. 13 illustrates the maximum heating and dehumidification mode of the vehicle heat pump system according to the second embodiment of the invention.

FIG. 14 illustrates the partial heating mode of the vehicle heat pump system according to the second embodiment of the invention.

FIG. 15 illustrates the partial heating and dehumidification mode of the vehicle heat pump system according to the second embodiment of the invention.

### MODE FOR INVENTION

Hereinafter, referring to attached drawings, a technical configuration of a heat pump system for a vehicle according to an embodiment of the present invention will described in detail as follows.

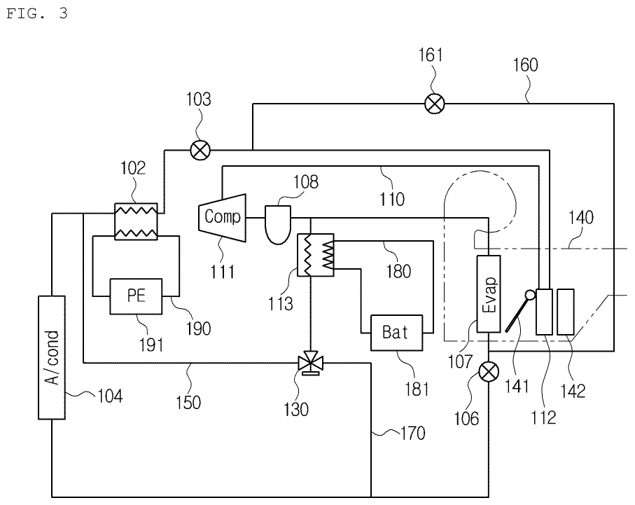

Referring to FIG. 3, the vehicle heat pump system according to a first embodiment of the invention is installed in an electric vehicle (EV) which include a battery 181 and electric components 191 such as a power electric module (PE module). The vehicle heat pump system includes a refrigerant line 110, a first cooling water line 190, a second cooling water line 180, an outdoor unit bypass line 150, an evaporator bypass line 170, and a dehumidification line 160.

In the refrigerant line 110, a compressor 111, an indoor heat exchanger 112, a first expansion valve 103, a water-cooled condenser 102, an outdoor heat exchanger 104, a second expansion valve 106, an evaporator 107, and an accumulator 108 are sequentially arranged. The compressor 111 compresses a refrigerant and discharges the refrigerant in a high-temperature and high-pressure state. The indoor heat exchanger 112 is located within an air-conditioning case 140, and heats the interior by exchanging heat between the air and the refrigerant discharged from the compressor 111.

The evaporator 107 and the indoor heat exchanger 112 are sequentially arranged within the air-conditioning case 140 in the air flow direction. A blower unit for blowing air is provided at an air inflow port of the air-conditioning case 140. A temperature door 141 for adjusting the temperature of the air discharged into the vehicle interior is provided between the evaporator 107 and the indoor heat exchanger 112. The temperature door 141 rotates within the air-conditioning case 140 to adjust the amount of air between a cold air passage and a warm air passage. A PTC heater 142 can be additionally provided downstream of the indoor heat exchanger 112 in the air flow direction.

The first expansion valve 103 is positioned between the indoor heat exchanger 112 and the water-cooled condenser 102, and selectively expands the refrigerant or allows the refrigerant to pass through without expansion. Furthermore, the water-cooled condenser 102 is provided downstream of the indoor heat exchanger 112 in the refrigerant flow direction, and exchanges heat with the first cooling water. That is, the water-cooled condenser 102 is positioned between the first expansion valve 103 and the outdoor heat exchanger 104, and exchanges heat with the first cooling water of the first cooling water line 190 circulating through the electric components 191.

The outdoor heat exchanger 104 is provided downstream of the water-cooled condenser 102 in the refrigerant flow direction, and exchanges heat between the refrigerant and the outdoor air. The second expansion valve 106 is provided upstream of the evaporator 107 in the refrigerant flow direction, and functions to expand the refrigerant. That is, the second expansion valve 106 is provided between the outdoor heat exchanger 104 and the evaporator 107 and solely performs the expansion function of the refrigerant. The evaporator 107 is located within the air-conditioning case 140, and cools the interior by exchanging heat between the refrigerant and the air.

The outdoor unit bypass line 150 allows the refrigerant passing through the water-cooled condenser 102 to bypass the outdoor heat exchanger 104. The evaporator bypass line 170 branches between the outdoor heat exchanger 104 and the second expansion valve 106 and is connected between the evaporator 107 and the accumulator 108. The evaporator bypass line 170 allows the refrigerant passing through the outdoor heat exchanger 104 to bypass the evaporator 107.

A chiller 113 is provided in the evaporator bypass line 170. That is, the chiller 113 is provided downstream of the outdoor heat exchanger 104 in the refrigerant flow direction and is provided on the refrigerant line bypassing the evaporator 107, to exchange heat with the second cooling water. The chiller 113 exchanges heat with the second cooling water of the second cooling water line 180 circulating through the battery 181. The outdoor unit bypass line 150 branches between the water-cooled condenser 102 and the outdoor heat exchanger 104, and is connected upstream of the chiller 113 in the refrigerant flow direction.

The vehicle heat pump system includes a refrigerant flow direction-changing valve 130. The refrigerant flow direction-changing valve 130 is arranged at a connection portion between the outdoor unit bypass line 150 and the refrigerant line upstream of the chiller 113. The refrigerant flow direction-changing valve 130 functions as a three-way valve, which controls the refrigerant passing through the water-cooled condenser 102 to selectively pass through or bypass the outdoor heat exchanger 104, and performs the function of expanding the refrigerant. That is, the refrigerant flow direction-changing valve 130 does not expand the refrigerant flowing to the chiller 113 after passing through the water-cooled condenser 102 but expands only the refrigerant passing through the outdoor heat exchanger 104.

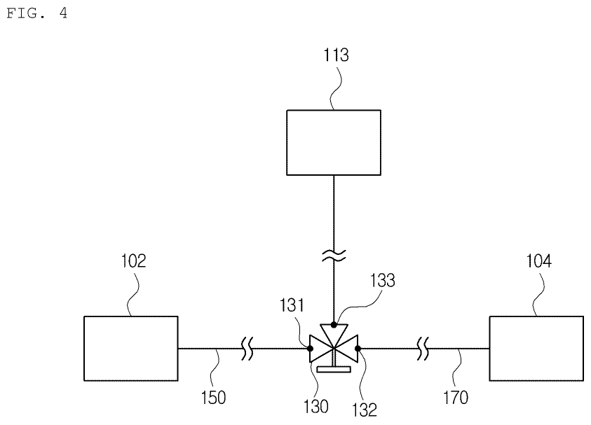

Referring to FIG. 4, the refrigerant flow direction-changing valve 130 includes two inlets 131 and 132 and one outlet 133. The first inlet 131 is connected to a branch line between the water-cooled condenser 102 and the outdoor heat exchanger 104, the second inlet 132 is connected downstream of the outdoor heat exchanger 104 in the refrigerant flow direction, and the outlet 133 is connected to the chiller 113. Namely, the first inlet 131 is connected to the outdoor unit bypass line 150, and the second inlet 132 is connected to the evaporator bypass line 170.

Additionally, the first inlet 131 performs only the on/off function of the refrigerant flow, and the second inlet 132 is configured to perform the refrigerant flow on/off function and the refrigerant expansion function. In this case, the refrigerant flow direction-changing valve 130 has an electronic expansion valve (EXV) structure capable of controlling the refrigerant amount. Moreover, the first expansion valve 103 is the electronic expansion valve (EXV) capable of controlling the refrigerant amount, and the second expansion valve 106 is a thermostatic expansion valve (TXV) which performs only the expansion function.

The dehumidification line 160 branches downstream of the indoor heat exchanger 112 in the refrigerant flow direction, and is connected to the upstream side of the evaporator 107. More specifically, the dehumidification line 160 is connected to the refrigerant line between the second expansion valve 106 and the evaporator 107. Moreover, the dehumidification line 160 branches between the indoor heat exchanger 112 and the first expansion valve 103. A third expansion valve 161 is provided in the dehumidification line 160. The third expansion valve 161 has the electronic expansion valve (EXV) structure to control the amount of refrigerant flowing through the dehumidification line 160 and expand the refrigerant.

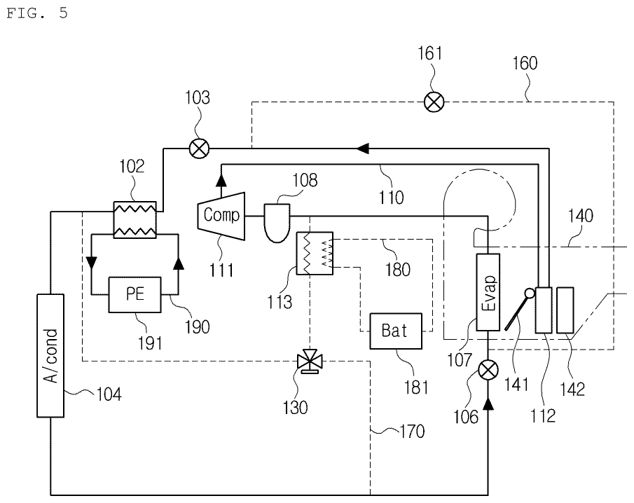

Referring to FIG. 5, in the cooling mode, the refrigerant flow direction-changing valve 130 closes both inlets 131 and 132 to block the refrigerant flow. The high-temperature and high-pressure refrigerant discharged from the compressor 111 passes through the indoor heat exchanger 112, directly goes through the first expansion valve 103, is primarily condensed while passing through the water-cooled condenser 102, and then, is secondarily condensed while passing through the outdoor heat exchanger 104. The refrigerant passing through the outdoor heat exchanger 104 expands at the second expansion valve 106, absorbs heat in the evaporator 107, passes through the accumulator 108, and then circulates through the compressor 111.

As described above, the air passing through the evaporator 107 exchanges heat with the refrigerant, thereby performing interior cooling. The third expansion valve 161 turns off the refrigerant flow so that the refrigerant does not flow into the dehumidification line 160. Furthermore, when the first inlet 131 and the second inlet 132 of the refrigerant flow direction-changing valve 130 are closed, the refrigerant does not flow into the outdoor unit bypass line 150 and the evaporator bypass line 170, and thus no battery 181 cooling occurs in the chiller 113.

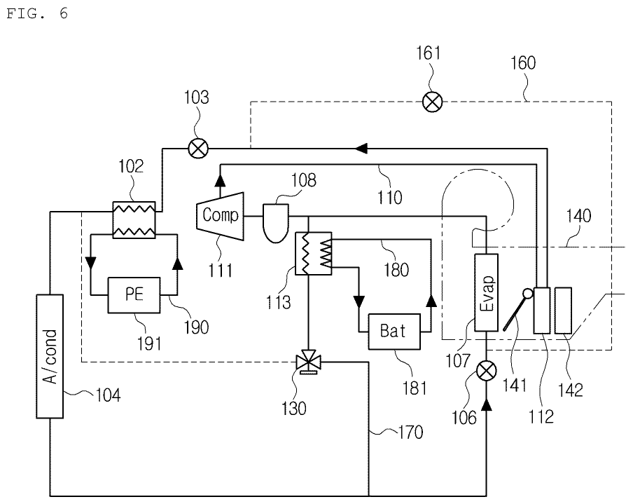

Referring to FIG. 6, in the cooling and battery cooling mode, the refrigerant flow direction-changing valve 130 opens only the second inlet 132 of the connection line downstream of the outdoor heat exchanger 104 in the refrigerant flow direction, and expands the refrigerant. That is, a portion of the refrigerant passing through the outdoor heat exchanger 104 is controlled to pass through the chiller 113. The high-temperature and high-pressure refrigerant discharged from the compressor 111 passes through the indoor heat exchanger 112, directly goes through the first expansion valve 103, is primarily condensed while passing through the water-cooled condenser 102, and then, is secondarily condensed while passing through the outdoor heat exchanger 104.

A portion of the refrigerant passing through the outdoor heat exchanger 104 is expanded at the second expansion valve 106, absorbs heat in the evaporator 107, passes through the accumulator 108, and then, circulates through the compressor 111. Another portion of the refrigerant is expanded at the refrigerant flow direction-changing valve 130, absorbs heat in the chiller 113, passes through the accumulator 108, and then circulates through the compressor 111. The air passing through the evaporator 107 is cooled by exchanging heat with the refrigerant, thereby performing interior cooling. The third expansion valve 161 turns off the refrigerant flow, such that the refrigerant does not flow into the dehumidification line 160. Additionally, when the second inlet 132 of the refrigerant flow direction-changing valve 130 is opened and the refrigerant is expanded, battery 181 cooling is achieved in the chiller 113.

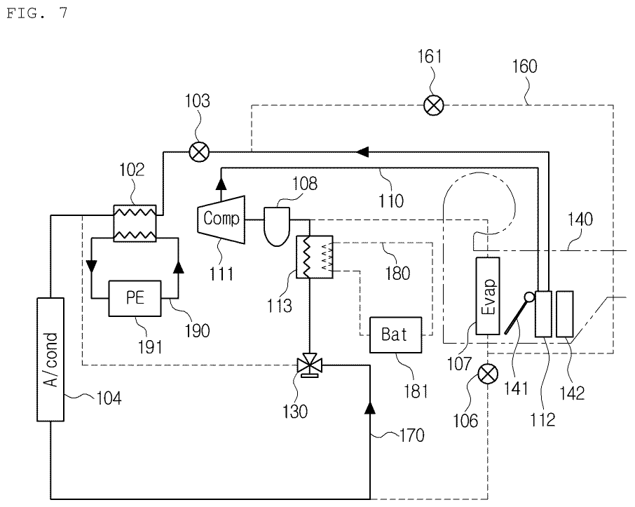

Referring to FIG. 7, in the maximum heating mode, the refrigerant flow direction-changing valve 130 opens only the second inlet 132 of the connection line downstream of the outdoor heat exchanger 104 in the refrigerant flow direction, and allows the refrigerant to pass through directly. The high-temperature and high-pressure refrigerant discharged from the compressor 111 exchanges heat with the indoor air while passing through the indoor heat exchanger 112, to perform interior heating. Additionally, the refrigerant passing through the indoor heat exchanger 112 is expanded while passing through the first expansion valve 103, recovers water heat source while passing through the water-cooled condenser 102, and recovers air heat source while passing through the outdoor heat exchanger 104.

The refrigerant passing through the outdoor heat exchanger 104 sequentially passes through the refrigerant flow direction-changing valve 130, the chiller 113, and the accumulator 108, and then, circulates through the compressor 111. The third expansion valve 161 turns off the refrigerant flow, such that the refrigerant does not flow into the dehumidification line 160. Additionally, when the second inlet 132 of the refrigerant flow direction-changing valve 130 is opened, the refrigerant passing through the outdoor heat exchanger 104 flows to the chiller 113 without expansion.

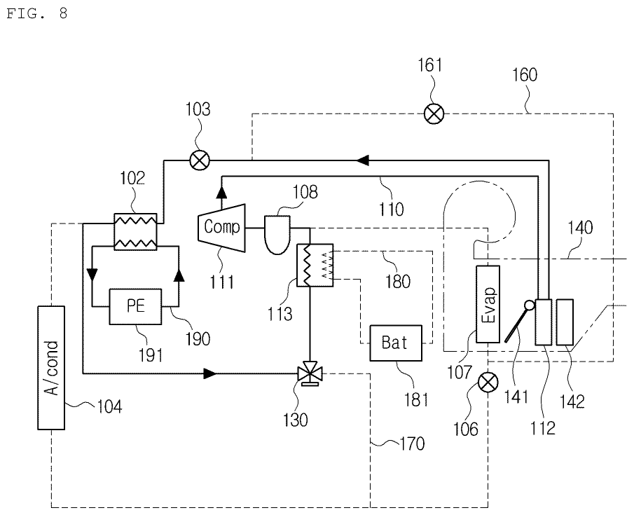

Referring to FIG. 8, in the partial heating mode, the refrigerant flow direction-changing valve 130 opens only the first inlet 131 of the branch line between the water-cooled condenser 102 and the outdoor heat exchanger 104. The high-temperature and high-pressure refrigerant discharged from the compressor 111 exchanges heat with the indoor air while passing through the indoor heat exchanger 112, to perform interior heating. The refrigerant passing through the indoor heat exchanger 112 is expanded while passing through the first expansion valve 103, recovers water heat source while passing through the water-cooled condenser 102, and then, sequentially passes through the refrigerant flow direction-changing valve 130, the chiller 113, and the accumulator 108, and then, circulates through the compressor 111.

The third expansion valve 161 turns off the refrigerant flow, such that the refrigerant does not flow into the dehumidification line 160. Additionally, when the first inlet 131 of the refrigerant flow direction-changing valve 130 is opened, the refrigerant passing through the water-cooled condenser 102 bypasses the outdoor heat exchanger 104, and then, changes the direction toward the refrigerant flow direction-changing valve 130 to flow to the chiller 113.

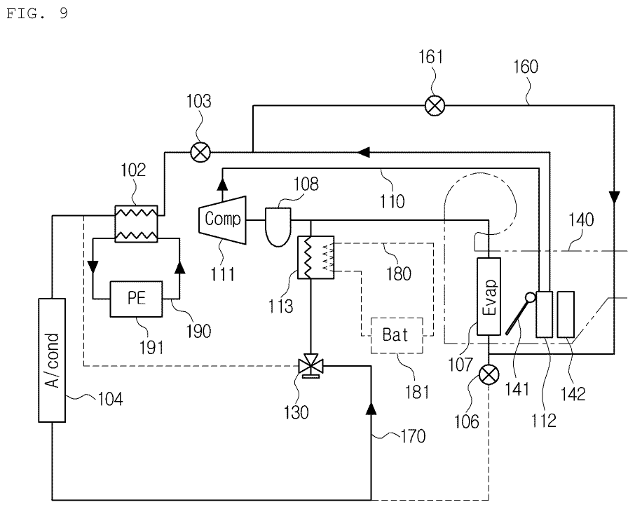

Referring to FIG. 9, in the maximum heating and dehumidification mode, the refrigerant flow direction-changing valve 130 opens only the second inlet 132 of the connection line downstream of the outdoor heat exchanger 104 in the refrigerant flow direction, and allows the refrigerant to pass through directly. The high-temperature and high-pressure refrigerant discharged from the compressor 111 exchanges heat with the indoor air while passing through the indoor heat exchanger 112, to perform interior heating. Additionally, the refrigerant passing through the indoor heat exchanger 112 is expanded while passing through the first expansion valve 103, recovers water heat source while passing through the water-cooled condenser 102, and recovers air heat source while passing through the outdoor heat exchanger 104.

The refrigerant passing through the outdoor heat exchanger 104 sequentially passes through the refrigerant flow direction-changing valve 130, the chiller 113, and the accumulator 108, and then, circulates through the compressor 111. The third expansion valve 161 turns on the refrigerant flow and expands the refrigerant, such that a portion of the refrigerant passing through the indoor heat exchanger 112 is supplied to the evaporator 107 through the dehumidification line 160, thereby performing interior dehumidification. Additionally, when the second inlet 132 of the refrigerant flow direction-changing valve 130 is opened, the refrigerant passing through the outdoor heat exchanger 104 flows to the chiller 113 without expansion.

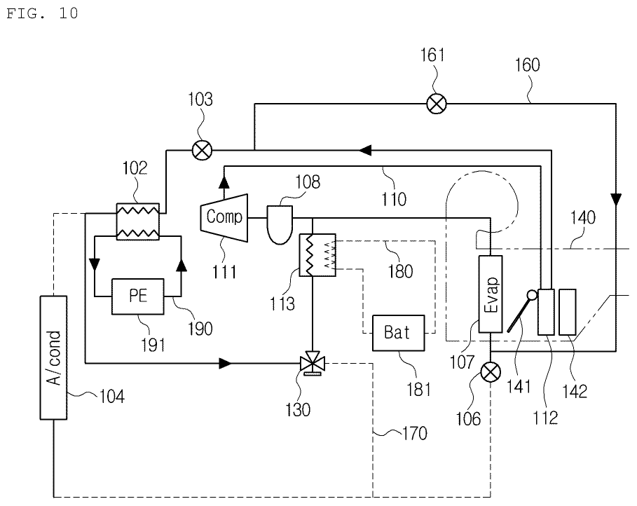

Referring to FIG. 10, in the partial heating and dehumidification mode, the refrigerant flow direction-changing valve 130 opens only the first inlet 131 of the branch line between the water-cooled condenser 102 and the outdoor heat exchanger 104. The high-temperature and high-pressure refrigerant discharged from the compressor 111 exchanges heat with the indoor air while passing through the indoor heat exchanger 112, to perform interior heating. The refrigerant passing through the indoor heat exchanger 112 is expanded while passing through the first expansion valve 103, recovers water heat source while passing through the water-cooled condenser 102, and then, sequentially passes through the refrigerant flow direction-changing valve 130, the chiller 113, and the accumulator 108, and then, circulates through the compressor 111.

The third expansion valve 161 turns on the refrigerant flow and expands the refrigerant, such that a portion of the refrigerant passing through the indoor heat exchanger 112 is supplied to the evaporator 107 through the dehumidification line 160, thereby performing interior dehumidification. In addition, when the first inlet 131 of the refrigerant flow direction-changing valve 130 is opened, the refrigerant passing through the water-cooled condenser 102 bypasses the outdoor heat exchanger 104, and then, changes the direction toward the refrigerant flow direction-changing valve 130 to flow to the chiller 113.

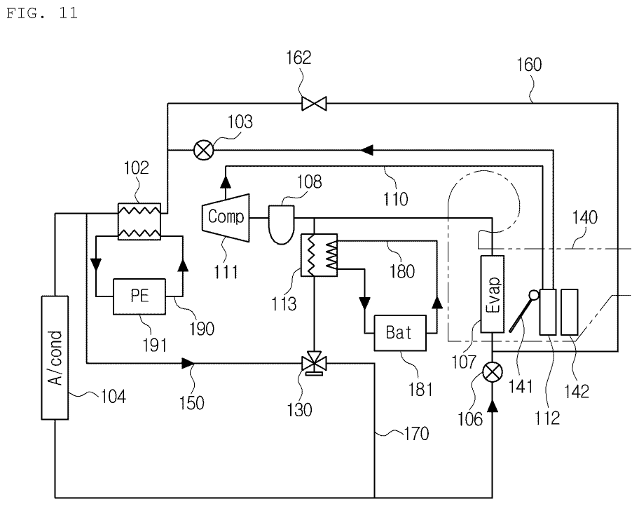

Meanwhile, referring to FIG. 11, a vehicle heat pump system according to a second embodiment of the present invention differs from the vehicle heat pump system according to the first embodiment in branch position of the dehumidification line 160. Other configurations are the same as in the first embodiment, so are not further described hereinafter.

The dehumidification line 160 according to the second embodiment branches between the first expansion valve 103 and the water-cooled condenser 102. Furthermore, the dehumidification line 160 includes a shut-off valve 162 for controlling only the amount of refrigerant flowing through the dehumidification line 160, thereby controlling the degree of dehumidification. Since the electronic expansion valves (EXV) are relatively expensive, the second embodiment uses a relatively inexpensive shut-off valve 162, which can effectively control the degree of dehumidification by controlling the amount of already expanded refrigerant heading to the evaporator 107 from the first expansion valve 103.

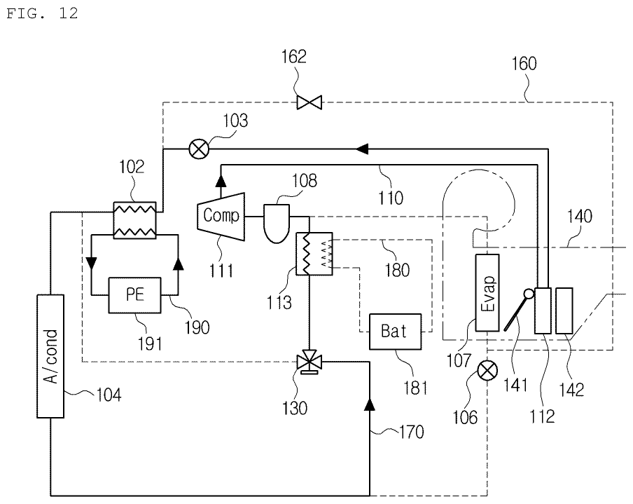

Referring to FIG. 12, in the maximum heating mode, the refrigerant flow direction-changing valve 130 opens only the second inlet 132 of the connection line downstream of the outdoor heat exchanger 104 in the refrigerant flow direction, and allows the refrigerant to pass through directly. The high-temperature and high-pressure refrigerant discharged from the compressor 111 exchanges heat with the indoor air while passing through the indoor heat exchanger 112, to perform interior heating. Additionally, the refrigerant passing through the indoor heat exchanger 112 is expanded while passing through the first expansion valve 103, recovers water heat source while passing through the water-cooled condenser 102, and recovers air heat source while passing through the outdoor heat exchanger 104.

The refrigerant passing through the outdoor heat exchanger 104 sequentially passes through the refrigerant flow direction-changing valve 130, the chiller 113, and the accumulator 108, and then, circulates through the compressor 111. The shut-off valve 162 turns off the refrigerant flow, such that the refrigerant does not flow into the dehumidification line 160. Additionally, when the second inlet 132 of the refrigerant flow direction-changing valve 130 is opened, the refrigerant passing through the outdoor heat exchanger 104 flows to the chiller 113 without expansion.

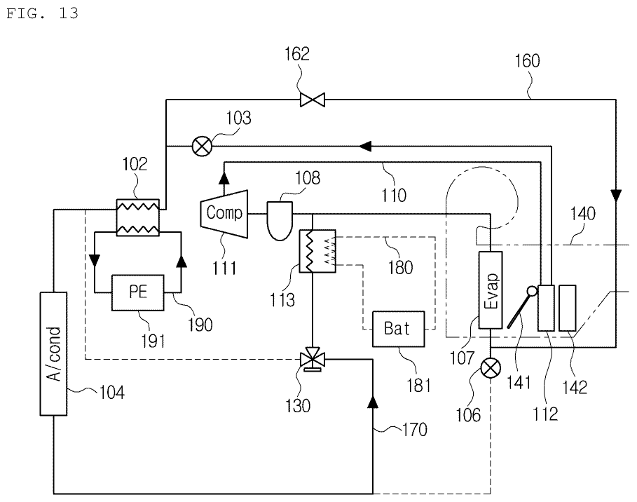

Referring to FIG. 13, in the maximum heating and dehumidification mode, the refrigerant flow direction-changing valve 130 opens only the second inlet 132 of the connection line downstream of the outdoor heat exchanger 104 in the refrigerant flow direction, and allows the refrigerant to pass through directly. The high-temperature and high-pressure refrigerant discharged from the compressor 111 exchanges heat with the indoor air while passing through the indoor heat exchanger 112, to perform interior heating. Additionally, the refrigerant passing through the indoor heat exchanger 112 is expanded while passing through the first expansion valve 103, recovers water heat source while passing through the water-cooled condenser 102, and recovers air heat source while passing through the outdoor heat exchanger 104.

The refrigerant passing through the outdoor heat exchanger 104 sequentially passes through the refrigerant flow direction-changing valve 130, the chiller 113, and the accumulator 108, and then, circulates through the compressor 111. The shut-off valve 162 turns on the refrigerant flow, so that a portion of the refrigerant passing through the first expansion valve 103 is supplied to the evaporator 107 via the dehumidification line 160, thereby performing interior dehumidification. Additionally, when the second inlet 132 of the refrigerant flow direction-changing valve 130 is opened, the refrigerant passing through the outdoor heat exchanger 104 flows to the chiller 113 without expansion.

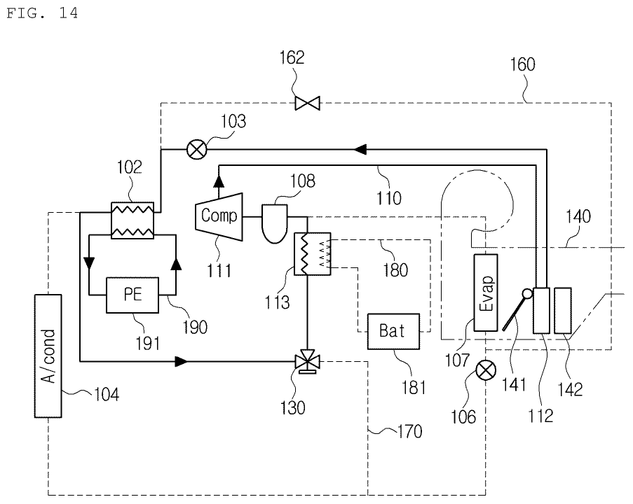

Referring to FIG. 14, in the partial heating mode, the refrigerant flow direction-changing valve 130 opens only the first inlet 131 of the branch line between the water-cooled condenser 102 and the outdoor heat exchanger 104. The high-temperature and high-pressure refrigerant discharged from the compressor 111 exchanges heat with the indoor air while passing through the indoor heat exchanger 112, to perform interior heating. The refrigerant passing through the indoor heat exchanger 112 is expanded while passing through the first expansion valve 103, recovers water heat source while passing through the water-cooled condenser 102, and then, sequentially passes through the refrigerant flow direction-changing valve 130, the chiller 113, and the accumulator 108, and then, circulates through the compressor 111.

The shut-off valve 162 turns off the refrigerant flow so that the refrigerant does not flow into the dehumidification line 160. Additionally, when the first inlet 131 of the refrigerant flow direction-changing valve 130 is opened, the refrigerant passing through the water-cooled condenser 102 bypasses the outdoor heat exchanger 104, and then, changes the direction toward the refrigerant flow direction-changing valve 130 to flow to the chiller 113.

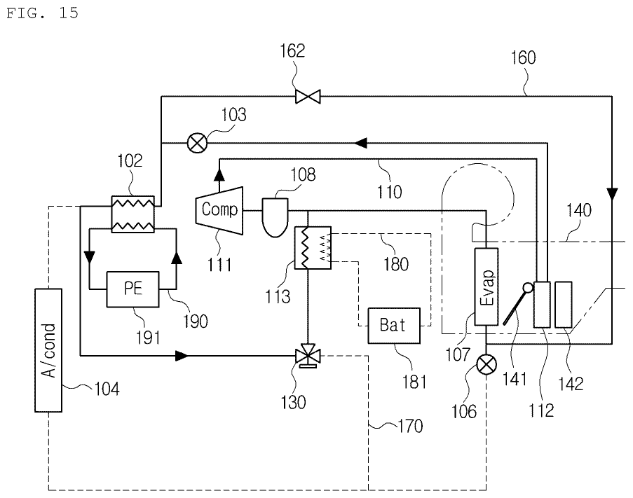

Referring to FIG. 15, in the partial heating and dehumidification mode, the refrigerant flow direction-changing valve 130 opens only the first inlet 131 of the branch line between the water-cooled condenser 102 and the outdoor heat exchanger 104. The high-temperature and high-pressure refrigerant discharged from the compressor 111 exchanges heat with the indoor air while passing through the indoor heat exchanger 112, to perform interior heating. The refrigerant passing through the indoor heat exchanger 112 is expanded while passing through the first expansion valve 103, recovers water heat source while passing through the water-cooled condenser 102, and then, sequentially passes through the refrigerant flow direction-changing valve 130, the chiller 113, and the accumulator 108, and then, circulates through the compressor 111.

The shut-off valve 162 turns on the refrigerant flow, so that a portion of the refrigerant passing through the first expansion valve 103 is supplied to the evaporator 107 via the dehumidification line 160, thereby performing interior dehumidification. Additionally, when the first inlet 131 of the refrigerant flow direction-changing valve 130 is opened, the refrigerant passing through the water-cooled condenser 102 bypasses the outdoor heat exchanger 104, and then, changes the direction toward the refrigerant flow direction-changing valve 130 to flow to the chiller 113.

In summary, the vehicle heat pump system according to the present invention uses a composite heat source in the heating mode, and is configured to allow the refrigerant passing through the water-cooled condenser 102 to flow to the outdoor heat exchanger 104 in series. The refrigerant flow direction-changing valve 130 which integrates with the functions of a three-way valve and an expansion valve functions as the expansion valve on the chiller 113 for the battery to perform refrigerant expansion and refrigerant flow adjustment in the cooling mode, and functions as the three-way valve in the heating mode.

In more detail, the refrigerant flow direction-changing valve 130 allows the refrigerant sequentially passing through the water-cooled condenser 102 and the outdoor heat exchanger 104 to flow to the chiller 113 in the maximum heating mode and allows the refrigerant passing through the water-cooled condenser 102 to flow to the chiller 113 in the partial heating mode, thereby realizing the outdoor heat exchanger bypass mode.

To realize the outdoor heat exchanger bypass mode, the refrigerant flow direction-changing valve 130 must be equipped with two inlets 131 and 132 and one outlet 133, and is configured to send the refrigerant introduced into the first inlet 131 to the outlet 133 in the full open state or send the refrigerant introduced into the second inlet 132 to the outlet 133 in the expansion or full open state. Furthermore, the refrigerant flow direction-changing valve 130 is configured to close all of the two inlets 131 and 132.

Meanwhile, to realize the dehumidification mode, a dehumidification line 160 and a third expansion valve 161 are used to actively adjust the refrigerant flow amount toward the evaporator 107, thereby sufficiently ensuring dehumidification performance under various conditions (maximum heating, partial heating, and so on). Furthermore, the vehicle heat pump system can realize the dehumidification mode due to optimization of the branch location of the dehumidification line without adding an EXV, thereby greatly reducing costs.

Additionally, the present invention can secure price competitiveness and realize all functions of the heat pump. That is, the vehicle heat pump system can realize all air-conditioning modes, such as the cooling mode, the cooling and battery cooling mode, the maximum heating mode, the maximum heating and dehumidification mode, the partial heating mode, and the partial heating and dehumidification mode, by controlling the refrigerant flow using total four valves. That is, all air-conditioning modes may be implemented using a total of four expansion valves of the first expansion valve 103, the second expansion valve 106, the third expansion valve 161, and the refrigerant flow direction-changing valve 130.

To realize all of the air-conditioning modes, the conventional configuration requires at least five expansion valves. However, the vehicle heat pump system according to the present invention can reduce the number of expansion valves and realize various air-conditioning modes through optimization in the branch positions and connection positions of the outdoor unit bypass line 150 and the evaporator bypass line 170, and the position of the refrigerant flow direction-changing valve 130.

Furthermore, the second expansion valve 106 can be a thermostatic expansion valve (TXV) which is more inexpensive than the electronic expansion valve (EXV), thereby significantly reducing manufacturing costs. By optimizing the branch location of the dehumidification line 160, the third expansion valve 161 can be replaced with the shut-off valve 162, which is more inexpensive than the EXV.

Meanwhile, to realize the same air-conditioning mode as the present invention using the conventional heat pump system, even if three electronic expansion valves (EXVs) are used, the mode capable of bypassing the outdoor heat exchanger in the heating mode cannot be realized. Accordingly, the outdoor heat exchanger bypass mode cannot be realized during the prevention of frosting on the outdoor heat exchanger, and the water heat source only mode through the outdoor heat exchanger bypass during the excessive generation of waste heat of the electric components cannot be realized.

In addition, a double-tube (internal heat exchanger) for distributing the refrigerant passing through the outdoor heat exchanger to the chiller and the evaporator during the heating dehumidification mode and enhancing cooling performance must be generally installed at the front end of the evaporator. Since the low-pressure refrigerant has to pass through the double-tube in order to pass through the evaporator for dehumidification, it causes deterioration in heat pump performance due to pressure loss. Furthermore, the water-cooled condenser is used in the cooling mode, but the utility of the water-cooled condenser becomes unclear in the heating mode. However, in the present invention, the double-tube (internal heat exchanger) is installed at the front end of the TXV (second expansion valve) after the battery chiller branch line based on the cooling mode, thereby minimizing the pressure loss of the refrigerant entering the chiller after passing the rear end of the outdoor heat exchanger during the heating mode.

While the heat pump system for the vehicle of the present invention has been described with reference to the illustrated embodiments, the descriptions are exemplary only, and it will be understood by those skilled in the art that various modifications and equivalents of the embodiments are possible. Therefore, the true technical protection scope should be defined by the technical spirit of the appended claims.

1. A vehicle heat pump system comprising:
a compressor for discharging a refrigerant;
an indoor heat exchanger which is provided in an air-conditioning case, and exchanges heat between air and the refrigerant discharged from the compressor to heat the interior;
a water-cooled condenser which is provided downstream of the indoor heat exchanger in the refrigerant flow direction, and exchanges heat with first cooling water;
an outdoor heat exchanger which is provided downstream or the water-cooled condenser in the refrigerant flow direction, and exchanges heat between the refrigerant and the outdoor air;
an evaporator which is provided in the air-conditioning case, and exchanges heat between the refrigerant and the air so as to cool the interior; and
a chiller which is provided downstream of the outdoor heat exchanger in the refrigerant flow direction, is provided in a refrigerant line bypassing the evaporator, and exchanges heat with second cooling water,
wherein an outdoor unit bypass line, which allows the refrigerant passing through the water-cooled condenser to bypass the outdoor heat exchanger, is provided, and
wherein the outdoor unit bypass line branches off between the water-cooled condenser and the outdoor heat exchanger and connects upstream of the chiller in the refrigerant flow direction.

2. The vehicle heat pump system according to claim 1, further comprising:
a refrigerant flow direction-changing valve which is arranged at a connection portion between the outdoor unit bypass line and the refrigerant line upstream of the chiller, and controls the refrigerant flow so that the refrigerant passing through the water-cooled condenser selectively passes through or bypasses the outdoor heat exchanger.

3. The vehicle heat pump system according to claim 2, wherein the refrigerant flow direction-changing valve performs the function of a three-way valve and the function of expanding the refrigerant.

4. The vehicle heat pump system according to claim 3, wherein the refrigerant flow direction-changing valve includes two inlets and one outlet, the first inlet is connected to a branch line between the water-cooled condenser and the outdoor heat exchanger, the second inlet is connected downstream of the outdoor heat exchanger in the refrigerant flow direction, and the outlet is connected to the chiller.

5. The vehicle heat pump system according to claim 4, wherein the first inlet performs only the on/off function of the refrigerant flow, and the second inlet is configured to perform the refrigerant flow on/off function and the refrigerant expansion function.

6. The vehicle heat pump system according to claim 3, further comprising:
a first expansion valve which is positioned between the indoor heat exchanger and the water-cooled condenser, and selectively expands the refrigerant or allows the refrigerant to pass through without expansion; and
a second expansion valve which is placed upstream of the evaporator in the refrigerant flow direction and expands the refrigerant.

7. The vehicle heat pump system according to claim 6, wherein the refrigerant flow direction-changing valve has an electronic expansion valve (EXV) structure capable of controlling the refrigerant amount, and
wherein the first expansion valve has an electronic expansion valve (EXV) structure capable of controlling the refrigerant amount, and the second expansion valve is a thermostatic expansion valve (TXV) performing only the expansion function.

8. The vehicle heat pump system according to claim 3, wherein the first cooling water circulates through electric components of a vehicle, and the second cooling water circulates through a battery of the vehicle.

9. The vehicle heat pump system according to claim 6, further comprising:
a dehumidification line which branches off downstream of the indoor heat exchanger in the refrigerant flow direction and connects upstream of the evaporator,
wherein the dehumidification line is connected between the second expansion valve and the evaporator.

10. The vehicle heat pump system according to claim 9, wherein the dehumidification line branches off between the indoor heat exchanger and the first expansion valve, and includes a third expansion valve capable of controlling the refrigerant amount and expanding the refrigerant.

11. The vehicle heat pump system according to claim 9, wherein the dehumidification line branches off between the first expansion valve and the water-cooled condenser, and includes a shut-off valve controlling only the refrigerant amount.

12. The vehicle heat pump system according to claim 6, wherein in a cooling mode, the refrigerant flow direction-changing valve closes all of the inlets to block the refrigerant flow, and controls the refrigerant to sequentially circulates through the compressor, the indoor heat exchanger, the first expansion valve, the water-cooled condenser, the outdoor heat exchanger, the second expansion valve, the evaporator, and the compressor, and
wherein in a cooling and battery cooling mode, the refrigerant flow direction-changing valve opens only the inlet of the connection line downstream of the outdoor heat exchanger in the refrigerant flow direction and expands the refrigerant, so that a portion of the refrigerant passing through the outdoor heat exchanger is controlled to pass through the chiller.

13. The vehicle heat pump system according to claim 6, wherein in a maximum heating mode, the refrigerant flow direction-changing valve opens only the inlet of the connection line downstream of the outdoor heat exchanger in the refrigerant flow direction and allows the refrigerant to pass through directly so that the refrigerant is controlled to sequentially circulate through the compressor, the indoor heat exchanger, the first expansion valve, the water-cooled condenser, the outdoor heat exchanger, the refrigerant flow direction-changing valve, the chiller, and the compressor, and
wherein in a partial heating mode, the refrigerant flow direction-changing valve opens only the inlet of the branch line between the water-cooled condenser and the outdoor heat exchanger so that the refrigerant is controlled to sequentially circulate through the compressor, the indoor heat exchanger, the first expansion valve, the water-cooled condenser, the refrigerant flow direction-changing valve, the chiller, and the compressor.

14. The vehicle heat pump system according to claim 9, wherein in a maximum heating and dehumidification mode, the refrigerant flow direction-changing valve opens only the inlet of the connection line downstream of the outdoor heat exchanger in the refrigerant flow direction and allows the refrigerant to pass through directly so that the refrigerant is controlled to sequentially circulate through the compressor, the indoor heat exchanger, the first expansion valve, the water-cooled condenser, the outdoor heat exchanger, the refrigerant flow direction-changing valve, the chiller, and the compressor, and a portion of the refrigerant passing through the indoor heat exchanger is supplied to the evaporator through the dehumidification line, and
wherein in a partial heating and dehumidification mode, the refrigerant flow direction-changing valve opens only the inlet of the branch line between the water-cooled condenser and the outdoor heat exchanger so that the refrigerant is controlled to sequentially circulate through the compressor, the indoor heat exchanger, the first expansion valve, the water-cooled condenser, the refrigerant flow direction-changing valve, the chiller, and the compressor, and a portion of the refrigerant passing through the indoor heat exchanger is supplied to the evaporator through the dehumidification line.

15. A vehicle heat pump system comprising:
a compressor for discharging a refrigerant;
an indoor heat exchanger which is provided in an air-conditioning case, and exchanges heat between air and the refrigerant discharged from the compressor to heat the interior;
a water-cooled condenser which is provided downstream of the indoor heat exchanger in the refrigerant flow direction, and exchanges heat with first cooling water;
an outdoor heat exchanger which is provided downstream of the water-cooled condenser in the refrigerant flow direction, and exchanges heat between the refrigerant and the outdoor air;
an evaporator which is provided in the air-conditioning case, and exchanges heat between the refrigerant and the air so as to cool the interior;
a chiller which is provided downstream of the outdoor heat exchanger in the refrigerant flow direction, is provided in a refrigerant line bypassing the evaporator, and exchanges heat with second cooling water; and
a refrigerant flow direction-changing valve which functions as a three-way valve controlling the refrigerant passing through the water-cooled condenser to selectively pass through or bypass the outdoor heat exchanger, and expands the refrigerant, and
wherein the refrigerant flow direction-changing valve expands only the refrigerant passing through the outdoor heat exchanger.
